(19) United States
(12) Patent Application Publication
(10) Pub. No.: US 2018/0030988 A1
(43) Pub. Date: Feb. 1, 2018

(54) BEARINGS FOR A TURBOCHARGER

(71) Applicant: BorgWarner Inc., Auburn Hills, MI (US)

(72) Inventors: Tyler R. GARRARD, Buellton, CA (US); Will R. HIPPEN, Santa Cruz, CA (US); Christopher MESZAROS, Brighton, MI (US)

(21) Appl. No.: 15/550,218

(22) PCT Filed: Feb. 9, 2016
(86) PCT No.: PCT/US16/17063

§ 371 Date: Aug. 10, 2017

Related U.S. Application Data
(60) Provisional application No. 62/114,632, filed on Feb. 11, 2015.

(51) Int. Cl. F04D 29/056; F04D 25/06; F04D 25/04; F16C 17/26

(52) U.S. Cl. CPC F04D 29/056; F16C 17/26; F04D 25/06; F04D 25/04; F16C 2360/24; F04D 17/10

(57) ABSTRACT

A turbocharger includes a housing, a shaft received therein, a turbine wheel affixed to the shaft at or adjacent to a first end thereof, a compressor wheel affixed to the shaft at or adjacent to a second, opposite end thereof, a first bearing received on the shaft between the turbine wheel and the compressor wheel, and a second bearing received on the shaft between the first bearing and the compressor wheel. One of the first and second bearings is floating relative to the shaft and affixed to the housing, and the other is floating relative to the shaft and also floating relative to the housing.

### CROSS-REFERENCE TO RELATED APPLICATION

This patent application claims the benefit of, and priority to, U.S. Provisional Patent Application Ser. No. 62/114,632, filed Feb. 11, 2015, the disclosure of which is expressly incorporated herein by reference.

### FIELD OF THE INVENTION

The present invention relates generally to support of a turbocharger shaft in a housing and, in particular, the use of bearings to support the shaft.

### BACKGROUND

Some turbochargers may operate at rotational speeds of up to 350,000 rpm in certain applications. Low-friction bearings and adequate support of the shaft lead to efficient operation and long operational life of the turbocharger. It is therefore desirable to design turbocharger bearings to achieve the dual goals of high stability and low friction.

### SUMMARY

The present invention may comprise one or more of the features recited in the attached claims, and/or one or more of the following features and combinations thereof. In a first example aspect, a turbocharger may comprise a turbocharger housing, a turbocharger shaft received within the turbocharger housing, a turbine wheel affixed to the turbocharger shaft at or adjacent to a first end thereof, a compressor wheel affixed to the turbocharger shaft at or adjacent to a second end thereof, the second end opposite the first end, a first bearing received on the turbocharger shaft between the turbine wheel and the compressor wheel, and a second bearing received on the turbocharger shaft between the first bearing and the compressor wheel. One of the first and second bearings may be floating relative to the turbocharger shaft and affixed to the turbocharger housing, and the other of the first and second bearings may be floating relative to the turbocharger shaft and floating relative to the turbocharger housing.

A second example aspect includes the subject matter of the first example aspect, and wherein the turbocharger housing defines therein a first boss and a second boss, the first bearing disposed in the first boss and the second bearing disposed in the second boss, the one of the first and second bearings affixed to the housing being prevented from rotating relative to the respective one of the first and second bosses.

A third example aspect includes the subject matter of the second example aspect, and wherein the turbocharger housing defines a turbine housing portion defining the first boss therein and a compressor housing portion coupled to the turbine housing portion and defining the second boss therein.

A fourth example aspect includes the subject matter of any of the first-third example aspects, and further comprises an electric machine having a rotor affixed to the turbocharger shaft between the first and second bearings.

A fifth example aspect includes the subject matter of the fourth example aspect, and wherein the electric machine includes a stator coupled to the rotor and mounted within the turbocharger housing.

A sixth example aspect includes the subject matter of any of the first-fifth example aspects, and wherein the second end of the turbocharger is threaded, and further comprising a threaded nut configured to engage the threaded second end of the turbocharger shaft to secure the compressor wheel to the turbocharger shaft.

A seventh example aspect includes the subject matter of any of the first-fifth example aspects, and wherein the compressor wheel is one of press fit onto the turbocharger shaft and welded to the turbocharger shaft.

An eighth example aspect includes the subject matter of any of the first-fifth and seventh aspects, and wherein the turbine wheel is one of press fit onto the turbocharger shaft and welded to the turbocharger shaft.

A ninth example aspect includes the subject matter of any of the first-eighth example aspects, and wherein the first and second bearings each define an inside diameter, and wherein the inside diameter of the first bearing is greater than the inside diameter of the second bearing.

A tenth example aspect includes the subject matter of either of the second and third example aspects, and wherein the first and second bosses are each concentrically formed.

In an eleventh example aspect, a turbocharger may comprise a turbocharger housing defining first and second bosses therein, a turbocharger shaft received within the turbocharger housing, a turbine wheel affixed to the turbocharger shaft at or adjacent to a first end thereof, a compressor wheel affixed to the turbocharger shaft at or adjacent to a second end thereof, the second end opposite the first end, a first bearing received on the turbocharger shaft between the turbine wheel and the compressor wheel and disposed in the first boss, and a second bearing received on the turbocharger shaft between the first bearing and the compressor wheel and disposed in the second boss. One of the first and second bearings may be freely rotatable relative to both the turbocharger shaft and the respective one of the first and second bosses, and the other of the first and second bearings may be affixed to the turbocharger housing such that the turbocharger shaft freely rotatable relative to the other of the first and second bearings but the other of the first and second bearings is prevented from rotating relative to the respective one of the first and second bosses.

A twelfth example aspect includes the subject matter of the eleventh example aspect, and may further comprise an electric machine having a rotor affixed to the turbocharger shaft between the first and second bearings.

A thirteenth example aspect includes the subject matter of the twelfth example aspect, and wherein the electric machine includes a stator coupled to the rotor and mounted within the turbocharger housing.

A fourteenth example aspect includes the subject matter of either of the twelfth and thirteenth aspects, and wherein the turbocharger housing comprises a turbine housing portion defining the first boss therein, a compressor housing portion defining the second boss therein and an electric machine housing portion having the electric machine mounted therein, the turbine housing portion and the compressor housing portion each coupled to the electric machine housing portion.

A fifteenth example aspect includes the subject matter of any of the eleventh-fourteenth example aspects, and wherein the first and second bearings each define an inside diameter, and wherein the inside diameter of the first bearing is greater than the inside diameter of the second bearing.

In a sixteenth example aspect, a turbocharger may comprise a turbocharger housing defining first and second bosses therein, a turbocharger shaft received within the turbocharger housing, a turbine wheel affixed to the turbocharger shaft at or adjacent to a first end thereof, a compressor wheel affixed to the turbocharger shaft at or adjacent to a second end thereof, the second end opposite the first end, a first bearing received on the turbocharger shaft between the turbine wheel and the compressor wheel and disposed in the first boss, the first bearing freely rotatable relative to both the turbocharger shaft and the first boss, and a second bearing received on the turbocharger shaft between the first bearing and the compressor wheel and disposed in the second boss, the second bearing secured to the turbocharger housing such that the turbocharger shaft is freely rotatable relative to the second bearing but the second bearing is prevented from rotating relative to the second boss.

A seventeenth example aspect includes the subject matter of the sixteenth example aspect, and may further comprise an electric machine having a rotor affixed to the turbocharger shaft between the first and second bearings.

An eighteenth example aspect includes the subject matter of the seventeenth example aspect, and wherein the turbocharger housing comprises a turbine housing portion defining the first boss therein, a compressor housing portion defining the second boss therein and an electric machine housing portion having the electric machine mounted therein, the turbine housing portion and the compressor housing portion each coupled to the electric machine housing portion.

A nineteenth example aspect includes the subject matter of any of the sixteenth-eighteenth example aspects, and wherein the first and second bearings each define an inside diameter, and wherein the inside diameter of the first bearing is greater than the inside diameter of the second bearing.

A twentieth example aspect includes the subject matter of any of the sixteenth-nineteenth example aspects, and wherein the first and second bosses are each concentrically formed.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a cross-sectional view of a prior-art, electronically-controlled turbocharger (ECT) that includes a high-speed electric machine.

FIG. 2 is an exploded view of an embodiment of a turbocharger shaft and bearing arrangement that may be implemented in a turbocharger generally, and in particular, in an ECT such as that illustrated in FIG. 1.

FIG. 3 is an exploded view of an embodiment of a turbocharger shaft bearing arrangement configured to be secured to a housing of a turbocharger.

FIG. 4 is an assembled view of the turbocharger shaft bearing arrangement of FIG. 3 shown secured to the turbocharger housing.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

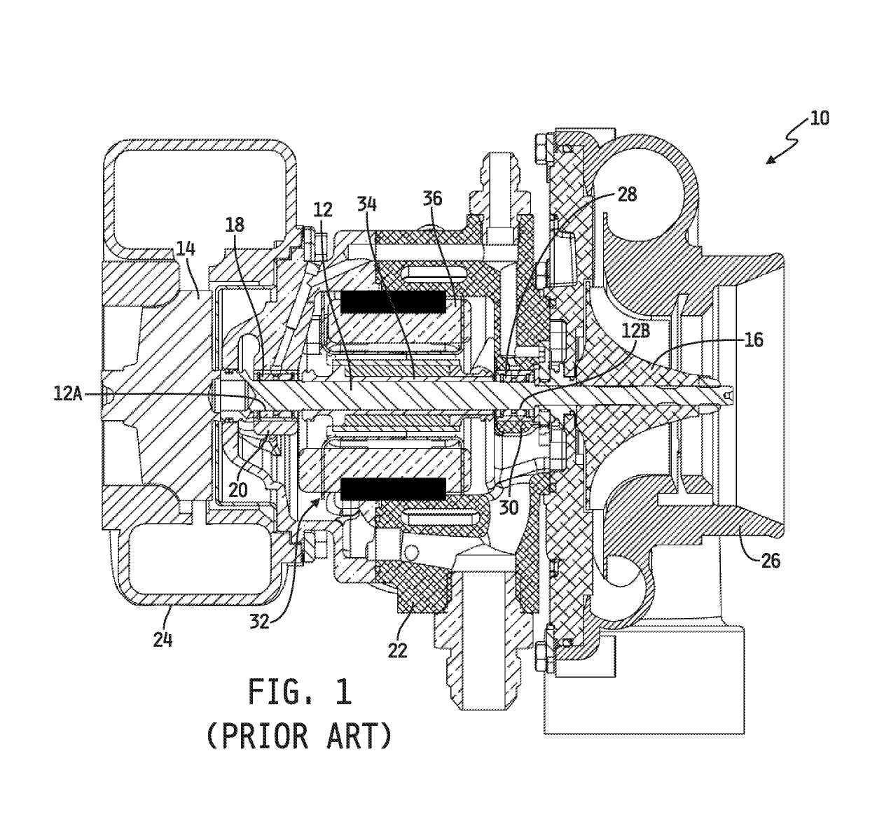

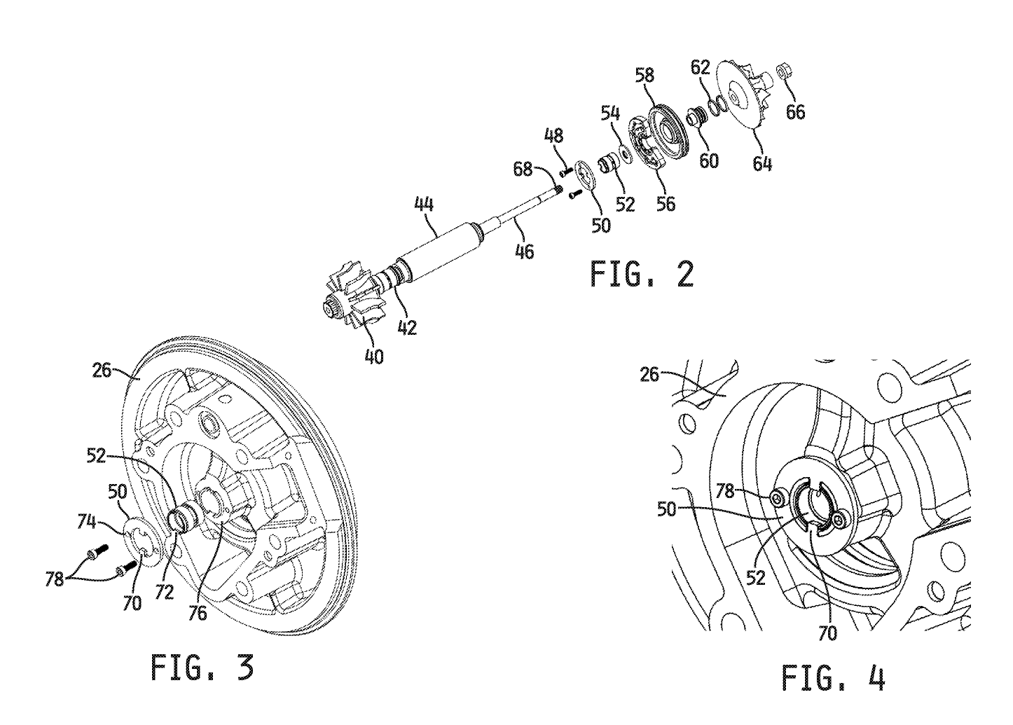

This disclosure is directed to a bearing arrangement for supporting a rotatable turbocharger shaft in, and relative to, a turbocharger housing. It will be understood that the bearing concepts illustrated and described herein are applicable to any conventional turbocharger including, for example, but not limited to, fixed geometry turbochargers, variable geometry turbochargers, so-called electronically controlled turbochargers (ECT) having one or more electric machines coupled thereto for controlling turbocharger rotational speed, and other conventional turbo-machinery. As will be described in detail with reference to FIGS. 2-4, the bearing arrangement that is the subject of this disclosure may be implemented in any such conventional turbocharger, and one example such turbocharger is the conventional ECT 10 illustrated in cross-section in FIG. 1.

Referring to FIG. 1, the illustrated ECT 10 has a turbocharger shaft 12 to which a turbine wheel 14 is affixed, e.g., by welding or other conventional turbine wheel affixing structure(s) and/or technique(s), at one end thereof. At an opposite end of the shaft 12 a compressor wheel 16 is affixed. In one embodiment, the compressor end of the turbocharger shaft 12 is threaded, and a complementarily threaded nut is advanced onto the shaft 12 to affix the compressor wheel 16 to the shaft 12. In alternative embodiments, other conventional structures and/or techniques may be used to affix the compressor wheel 16 to the shaft 12, examples of which include, but are not limited to, welding, press-fitting, or the like.

The turbocharger shaft 12 is supported by a pair of bearings 18 and 28, and each bearing 18, 28 is disposed in a boss or cradle 20, 30 respectively formed in the turbocharger housing. In the illustrated embodiment, the bearing 18 is disposed in the boss or cradle 20 in a turbine housing portion 24 of the turbocharger housing, and the bearing 28 is disposed in the boss or cradle 30 in a compressor housing portion 26 of the turbocharger housing. In some embodiments, the bosses or cradles 20, 30 are concentrically machined, although in alternate embodiments only one or neither may be concentrically machined.

In the illustrated embodiment, the outer diameter of the turbocharger shaft 12 is greater in a region 12A about which the bearing 18 is disposed than in the region 12B about which the bearing 28 is disposed. In this embodiment, the inner diameter of the bearing 18 is thus greater than that of the bearing 28, although it will be understood that in alternate embodiments the outer diameters of the shaft regions 12A, 12B, and therefore the inner diameters of the bearings 18, 28, may be the same or the outer diameter of the shaft region 12B/inner diameter of the bearing 28 may be greater than that of the outer diameter of the shaft region 12A/inner diameter of the bearing 18.

An electric machine 32, e.g. an electrically-controlled motor or motor/generator, includes a rotor 34 affixed to the turbocharger shaft 12 between the bearings 18, 28 such that the rotor 34 rotates with the shaft 12. A stator 36 is operatively coupled to the rotor 34, and the electric machine 32 is disposed within an electric machine housing portion 22 of the turbocharger housing. In the illustrated embodiment, the turbocharger housing is thus made up of three housing portions; the turbine housing portion 24, the compressor housing portion 26, and the electric machine housing portion 22. The turbine housing portion 24 and the compressor housing portion 26 are each illustratively affixed to the electric machine housing portion 22 in a conventional manner. Those skilled in the art will recognize that depending on the location of the splits between housing portions, the bosses 22 and 24 may be included in other housing portions of turbocharger 10, and that the embodiment illustrated in FIG. 1 is merely one non-limiting example thereof.

Referring now to FIG. 2, a partially exploded view is shown of a turbocharger shaft 46 including an embodiment of a bearing arrangement carried thereby. In the illustrated embodiment, a turbine wheel 40 is affixed to shaft 46 at or adjacent to one end thereof, e.g., by welding or other conventional fixation structure(s) and/or technique(s) such as a splined engagement, pressed collar, press fit, or the like. A bearing 42 is slidably received on and over the shaft 46 adjacent to the turbine wheel 40. In the illustrated embodiment, the bearing 42 is a fully-floating bearing; i.e., the bearing is not affixed to either the shaft 46 or the turbocharger housing, but rather is freely rotatable about the shaft 46 as well as within the boss or cradle 20 of the turbocharger housing. In one embodiment, oil or other lubricant is provided between bearing 42 and the boss 29 (not shown in FIG. 2 but shown in FIG. 1) as well as between the shaft 46 and the bearing 42. In any case, the bearing 42 is free to rotate relative to both the boss or cradle 20 and the shaft 46. Because the bearing 42 is freely floating, however, the bearing 42 illustratively rotates a lower rotational speed than that of the turbocharger shaft 46.

In the embodiment illustrated in FIG. 2, a rotor 44 of an electric machine is affixed to the shaft 46 by any conventional structure(s) and/or technique(s), e.g., such as a press fit, welding, threads, a nut or other structure pressing the rotor 44 into a shoulder or conical section of the shaft 46, a splined engagement, pressed collar, keyed engagement, and/or the like. A plate 50 having an opening defined therethrough is received on and over the turbocharger shaft 46 at an opposite end thereof, and another bearing 52 is, in turn, likewise received on and over the shaft 46 with the plate 50 positioned between the rotor 44 and the bearing 52. A thrust bearing assembly is then received on and over the turbocharger shaft 46 between the bearing 52 and the end of the shaft 46. In the illustrated embodiment, the thrust bearing assembly illustratively includes, in order of proximity to the bearing 52, a thrust bearing washer 54, a thrust bearing 56, a thrust bearing sealing plate 58, a compressor seal 60 and piston ring seals 62. A compressor wheel 64 is then affixed to the shaft 46 at or adjacent to the opposite end thereof, i.e., the end of the shaft 46 that is opposite to the end at which the turbine wheel 40 is affixed. In the illustrated embodiment, the opposite end of the turbocharger shaft 46 is provided with threads 68, and the compressor wheel 64 is affixed to the shaft by advancing a complementarily threaded nut 66 along the threads 68 such that the nut 66 engages the shaft 46 to secure the compressor wheel 64 thereto. In alternate embodiments, the compressor wheel 64 may be affixed to the shaft 46 via one or more other conventional fixation structure(s) and/or technique(s) such as welding, splined engagement, pressed collar, press fit, or the like.

In one embodiment, the bearing 52 illustratively defines one or more slots, channels or indentations therein, and the plate 50 illustratively defines one or more complementarily configured teeth, tangs or protrusions which engage the one or more slots, channels or indentations defined in the bearing 52 when the plate 50 and bearing 52 are received on the shaft 46 to prevent the bearing 52 from rotating relative to the plate 50. In some alternative embodiments, the plate 50 may defined the one or more slots, channels or indentations and the bearing may define the one or more teeth, tangs or protrusions. In any case, the plate 50 further illustratively defines one or more passageways or openings therethrough sized to receive conventional fixation members, e.g., screws, bolts, etc., therethrough. With the plate 50 and bearing 52 received on the shaft 46, the one or more slots, channels or indentations defined in the bearing 52 align with and engage the one or more corresponding teeth, tangs or protrusions defined in the plate 50, and the one or more openings or passageways defined through the plate 50 align with corresponding openings or passageways defined in the compressor housing portion 26 (and/or the electric machine housing portion 22) of the turbocharger housing. One or more conventional fixation members are passed through the openings or passageways defined through the plate 50 and into engagement with the aligned openings or passageways defined in the compressor housing portion 26 to secure the plate 50 and the bearing 52 to the turbocharger housing such that the bearing 52 and plate 50 are prevented from rotating relative to the turbocharger housing. In this manner, the bearing 152 is said to be “pinned” to the compressor housing portion 26 such that the bearing 152 cannot rotate relative to the turbocharger housing.

In the exploded view illustrated in FIG. 3 and in the assembled view illustrated in FIG. 4, a specific but non-limiting example of such a pinning arrangement is illustrated. In FIGS. 3 and 4, the turbocharger shaft 46 is omitted so as not to obscure the foregoing details of the plate 50, bearing 52 and compressor housing portion 26. In the illustrated embodiment, the plate 50 defines a pair of diametrically opposed teeth or tangs 70 each extending radially inwardly into a turbocharger shaft receiving opening defined centrally therethrough, and the bearing 52 defines a corresponding pair of diametrically opposed slots or channels 72 into an annular edge or rim thereof, wherein the teeth or tangs 70 and the slots or channels 72 are sized and configured such that the teeth or tangs 70 are received in the corresponding slots or channels 72 as illustrated in FIG. 3 such that the bearing 52 is prevented from rotating relative to the plate 50.

In the embodiment illustrated in FIGS. 3 and 4, the plate 50 further defines a pair of diametrically opposed openings or passageways 74 therethrough in the same plane as that of the turbocharger shaft receiving opening, and the compressor housing portion 26 likewise defines a pair of openings or passageways 76 therein which align with the openings or passageways 74. Fixation members 78, e.g., screws, are passed through the openings or passageways 74 and into engagement with the openings or passageways 76 to secure the plate 50 and bearing 52 to the compressor housing portion 26 such that the bearing 52 is prevented from rotating relative to the turbocharger housing.

In one embodiment, a thin layer of oil or other lubricant may be disposed between the bearing 52 and the boss 30 in the housing in which it is contained. In alternative embodiments, the bearing 52 may be fixed to the compressor housing portion 26 with no layer of oil or other lubricant disposed between the bearing 52 and the boss 30. In any case, the bearing 52 is pinned to the turbocharger housing such that it doesn't rotate with respect to the turbocharger housing.

In the illustrated embodiment, the bearing 52 is a partially floating bearing; that is, the bearing is affixed to the turbocharger housing but is floating, i.e., freely rotatable, relative to and about the shaft 46. In one embodiment, oil or other lubricant is provided between bearing 52 and the shaft 46. In any case, the bearing 52 is pinned to the turbocharger housing such that it is prevented from rotating relative to the boss or cradle 30 of the compressor housing portion 30 but is free to rotate relative to the turbocharger shaft 46.

In the illustrated embodiment, the bearing 42 is described as being freely floating with respect to the turbocharger shaft 46 and also with respect to the boss or cradle 20 of the turbocharger housing, and the bearing 52 is described as being pinned to the turbocharger housing but freely floating with respect to the turbocharger shaft 46. As such, the turbine-side bearing 42 may rotate relative to the boss or cradle 20 of the turbocharger housing and also relative to the turbocharger shaft 46, although because the bearing 42 is not affixed to the shaft 46 it generally will rotate at a lower rotational speed than that of the shaft 46, particularly if oil or other lubricant is disposed therebetween. The compressor-side bearing 52, on the other hand, is fixed relative to the boss 30 of the turbocharger housing because it is secured to the turbocharger housing by the plate 50, but is floating with respect to the turbocharger shaft 46. The bearing 52 may thus rotate relative to the turbocharger shaft 46 but is prevented from rotating relative to the turbocharger housing by the plate 50 which engages the bearing 52 and is affixed to the housing.

In alternative embodiments, the roles and structures of the bearings 42, 52 may be switched, i.e., the turbine side bearing 42 may be pinned to the turbocharger housing and floating with respect to the turbocharger shaft 46, e.g., as described above with respect to the bearing 52, and the compressor side bearing 52 may be freely floating, e.g., as described above with respect to the bearing 42.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected.

1. A turbocharger, comprising:
a turbocharger housing,
a turbocharger shaft received within the turbocharger housing,
a turbine wheel affixed to the turbocharger shaft at or adjacent to a first end thereof,
a compressor wheel affixed to the turbocharger shaft at or adjacent to a second end thereof, the second end opposite the first end,
a first bearing received on the turbocharger shaft between the turbine wheel and the compressor wheel, and
a second bearing received on the turbocharger shaft between the first bearing and the compressor wheel,
wherein one of the first and second bearings is floating relative to the turbocharger shaft and affixed to the turbocharger housing, and the other of the first and second bearings is floating relative to the turbocharger shaft and floating relative to the turbocharger housing.

2. The turbocharger of claim 1, wherein the turbocharger housing defines therein a first boss and a second boss, the first bearing disposed in the first boss and the second bearing disposed in the second boss, the one of the first and second bearings affixed to the housing being prevented from rotating relative to the respective one of the first and second bosses.

3. The turbocharger of claim 2, wherein the turbocharger housing defines a turbine housing portion defining the first boss therein and a compressor housing portion coupled to the turbine housing portion and defining the second boss therein.

4. The turbocharger of claim 1, further comprising an electric machine having a rotor affixed to the turbocharger shaft between the first and second bearings.

5. The turbocharger of claim 4, wherein the electric machine includes a stator coupled to the rotor and mounted within the turbocharger housing.

6. The turbocharger of claim 1, wherein the second end of the turbocharger shaft is threaded, and further comprising a threaded nut configured to engage the threaded second end of the turbocharger shaft to secure the compressor wheel to the turbocharger shaft.

7. The turbocharger of claim 1, wherein the compressor wheel is one of press fit onto the turbocharger shaft and welded to the turbocharger shaft.

8. The turbocharger of claim 1, wherein the turbine wheel is one of press fit onto the turbocharger shaft and welded to the turbocharger shaft.

9. The turbocharger of claim 1, wherein the first and second bearings each define an inside diameter, and wherein the inside diameter of the first bearing is greater than the inside diameter of the second bearing.

10. The turbocharger of claim 2, wherein the first and second bosses are each concentrically formed.

11. A turbocharger, comprising:
a turbocharger housing defining first and second bosses therein,
a turbocharger shaft received within the turbocharger housing,
a turbine wheel affixed to the turbocharger shaft at or adjacent to a first end thereof, a compressor wheel affixed to the turbocharger shaft at or adjacent to a second end thereof, the second end opposite the first end,
a first bearing received on the turbocharger shaft between the turbine wheel and the compressor wheel and disposed in the first boss, and
a second bearing received on the turbocharger shaft between the first bearing and the compressor wheel and disposed in the second boss,
wherein one of the first and second bearings is freely rotatable relative to both the turbocharger shaft and the respective one of the first and second bosses, and the other of the first and second bearings is affixed to the turbocharger housing such that the turbocharger shaft freely rotatable relative to the other of the first and second bearings but the other of the first and second bearings is prevented from rotating relative to the respective one of the first and second bosses.

12. The turbocharger of claim 11, further comprising an electric machine having a rotor affixed to the turbocharger shaft between the first and second bearings.

13. The turbocharger of claim 12, wherein the electric machine includes a stator coupled to the rotor and mounted within the turbocharger housing.

14. The turbocharger of claim 12, wherein the turbocharger housing comprises a turbine housing portion defining the first boss therein, a compressor housing portion defining the second boss therein and an electric machine housing portion having the electric machine mounted therein, the turbine housing portion and the compressor housing portion each coupled to the electric machine housing portion.

15. The turbocharger of claim 11, wherein the first and second bearings each define an inside diameter, and wherein the inside diameter of the first bearing is greater than the inside diameter of the second bearing.

16. A turbocharger, comprising:
a turbocharger housing defining first and second bosses therein,
a turbocharger shaft received within the turbocharger housing,
a turbine wheel affixed to the turbocharger shaft at or adjacent to a first end thereof,
a compressor wheel affixed to the turbocharger shaft at or adjacent to a second end thereof, the second end opposite the first end,
a first bearing received on the turbocharger shaft between the turbine wheel and the compressor wheel and disposed in the first boss, the first bearing freely rotatable relative to both the turbocharger shaft and the first boss, and
a second bearing received on the turbocharger shaft between the first bearing and the compressor wheel and disposed in the second boss, the second bearing secured to the turbocharger housing such that the turbocharger shaft is freely rotatable relative to the second bearing but the second bearing is prevented from rotating relative to the second boss.

17. The turbocharger of claim 16, further comprising an electric machine having a rotor affixed to the turbocharger shaft between the first and second bearings.

18. The turbocharger of claim 17, wherein the turbocharger housing comprises a turbine housing portion defining the first boss therein, a compressor housing portion defining the second boss therein and an electric machine housing portion having the electric machine mounted therein, the turbine housing portion and the compressor housing portion each coupled to the electric machine housing portion.

19. The turbocharger of claim 16, wherein the first and second bearings each define an inside diameter, and wherein the inside diameter of the first bearing is greater than the inside diameter of the second bearing.

20. The turbocharger of claim 16, wherein the first and second bosses are each concentrically formed.
